(19) United States
(12) Patent Application Publication
(10) Pub. No.: US 2011/0175987 A1
(43) Pub. Date: Jul. 21, 2011

(54) STEREO CAMERA SYSTEM

(75) Inventors: Matthias Hoffmeier, Berlin (DE); Stefan Pohl, Rostock (DE)

(73) Assignee: Hella KGaA Hueck & Co., Lippstadt (DE)

(21) Appl. No.: 13/056,379

(22) PCT Filed: Jul. 28, 2009
(86) PCT No.: PCT/EP2009/059729

§ 371 Date: Apr. 6, 2011

(30) Foreign Application Priority Data
Jul. 28, 2008 (DE) 10 2008 035 150.4

(51) Int. Cl. H04N 13/02

(52) U.S. Cl. 348/47; 348/E13.074

(57) ABSTRACT

The invention relates to a stereo camera system with at least two image detection sensors which are fixedly connected to a circuit board. The image detection sensors are coplanar and a fixed distance apart.

### FIELD OF THE INVENTION

The invention relates to a stereo camera system with at least two image detection sensors which each take at least one image with a visual representation of a detection range of the stereo camera system and generate image data corresponding to the image.

### BACKGROUND OF THE INVENTION

Known stereo camera systems have two single-frame cameras which have to be arranged individually and aligned exactly relative to each other. The alignment of the single-frame cameras relative to each other is also referred to as calibration. The image data generated by the single-frame cameras are transferred to a common evaluation unit which processes the transferred image data.

Due to various environmental influences on the single-frame cameras of the stereo camera systems it is required to check the position of the single-frame cameras relative to each other on a regular basis and, if necessary, to re-calibrate the stereo camera system.

From document EP 0 918 979 A1 a stereo camera for digital photogrammetry is known, which camera has an input optical system and a plurality of optical detectors arranged in the focal plane of the input optical system. By a suitable selection of the detectors, the stereo angle of this stereo camera can be varied.

From document DE 197 27 999 A1 a stereo camera is known in which two fully electronic cameras are electrically coupled by a parallel connection of target contacts.

From document EP 0 174 091 A1 a stereo camera with two lenses is known, which lenses can be focused simultaneously.

From document DE 199 05 452 C2 a digital stereo camera is known which has two lenses offset by a base length for generating an image pair of a visual representation of an object.

From document DE 100 33 355 A1 a stereo camera with two single cameras and one common evaluation unit is known.

From document WO 2006/069978 A, a method for determining a calibration parameter of a stereo camera is known. This calibration parameter is in particular used for calibrating two single cameras of a stereo camera system.

### SUMMARY OF THE INVENTION

It is the object of the invention to specify a stereo camera system in which the calibration expense is reduced. This object is realized by a stereo camera system having the features of claim 1; i.e., a board in the form of an insulative substrate having two image sensors affixed to it. Advantageous embodiments of the invention are specified in the dependent claims.

What is achieved by a stereo camera system having the features of claim 1 is that the position of the image detection sensors relative to each other, in particular the distance between the center points of the image sensing areas of the image detection sensors, is predetermined by the board, and the position of the image detection sensors is fixed by the connection to the board. The position of the image sensing areas of the image detection sensors relative to each other is thus defined on the board and invariable.

When similar or identical image detection sensors are used, it is thus in particular possible to arrange the image sensing areas of the image detection sensors in one plane. A stereo camera system set up in this way no longer has to be calibrated or, during calibration, only manufacturing tolerances have to be compensated. Such a calibration of the stereo camera system can, for example, take place by the determination of relevant parts of the image sensing area of the respective image detection sensor for the selection of an image to be further processed.

The image detection sensors are preferably joined to the board by at least one soldered joint or are each plugged into a socket fixedly connected to the board. By fixing the image detection sensors on the board, the position of the image sensing areas of the image detection sensors relative to each other is fixed in space, in particular in a camera coordinate system. This relative position of the image detection sensors to each other is invariable. By placing the image detection sensors on a common board a calibration of the single cameras is not necessary throughout the life of the stereo camera system. Preferably, the board is a known circuit board which has conducting tracks for connecting electrical terminals and/or signal terminals of the image detection sensors as well as preferably for contacting further components. With the aid of the image detection sensors, in particular color images or black-and-white images can be taken. By placing the image detection sensors on the board the image detection sensors can be arranged easily in a desired angle relative to a marginal edge of the board and at a desired distance to this marginal edge, in particular parallel to the marginal edge. As a result thereof, the calibration expense of such a stereo camera system can be considerably reduced compared to known stereo camera systems.

It is particularly advantageous to connect the optical system associated with each of the image detection sensors to the board and/or to the respective image detection sensor so that the position of the optical system relative to the image sensing area of the respective image detection sensor is simply fixed by the connection of the optical system to the board and/or to the image detection sensor. Here, it is advantageous to arrange the two optical systems relative to the board such that one visual representation each of a detection range of the stereo camera system is imaged and/or focused onto one image sensing area each of the image detection sensors. In particular, the respective optical axis of an optical system can run through the center point of the image sensing area of an image detection sensor. As a result thereof, the detection of images suitable for further processing can be guaranteed.

The board is preferably planar and resistant to bending. When using conventional boards and conventional image detection sensors, the displacement caused by manufacturing tolerances can be limited to ≧5 pixels in x and y direction of the image sensing areas of the image detection sensors. Here, an arrangement of the pixel sensing elements (arranged in matrix form) of the image sensing areas in a two-dimensional x-y-coordinate system is assumed.

The specified stereo camera system is particularly suitable for measuring the distance between the stereo camera system and an object in the range of ≧100 m, preferably in the range of ≧30 m. As a result thereof, this stereo camera system is particularly suitable for the counting of objects or persons, the detection of objects and the classification of objects at close range. The determination of the distance to the objects with the aid of the stereo camera system takes place in a known manner.

Optical semiconductor sensors, CCD image detection sensors and/or CMOS image detection sensors are particularly suitable as image detection sensors. It is particularly advantageous to use so-called active pixel sensors (APS) as image detection sensors. The board can in particular be made of phenol resin and paper, epoxy resin and paper or epoxy resin and glass-fiber fabric, each of which having conducting tracks. The conducting tracks can be formed with one layer (in one plane) or with multiple layers (in several planes), in particular as so-called multilayer circuit boards.

The distance between the center points of the image sensing areas of the image detection sensors preferably has a value in the range between 80 mm and 300 mm, preferably in the range between 80 mm and 100 mm. It is particularly advantageous to arrange—in addition to the image detection sensors—components of at least one evaluation unit on the board so that both the image detection sensors as well as the evaluation unit are arranged on the same board. As a result thereof, a space-saving placement of the components and thus a small physical size of the stereo camera system is possible. Further, the wiring expense is low as the transfer of the image data generated by the image detection sensors to the evaluation unit can take place via conducting tracks of the board.

It is particularly advantageous when a first marginal line of an image sensing area of the first image detection sensor and a first marginal line of an image sensing area of the second image detection sensor lie on a first straight line. Alternatively or additionally, it is advantageous when a second marginal line of the image sensing area of the first image detection sensor and a second marginal line of the image sensing area of the second image detection sensor lie on a second straight line. As a result thereof, a particularly easy further processing of the image data is possible as the images taken with the aid of the image detection sensors can simply be superimposed to easily determine the distance between the visual representations of the same object contained in the images simultaneously sensed by the image detection sensors. This distance is a measure of the distance between the stereo camera system and the imaged object.

It is particularly advantageous when the evaluation unit executes at least one image processing program for processing the image data generated by the image detection sensors. As a result thereof, an easy and flexible processing of the image data by the evaluation unit is possible. In particular, by using a suitable image processing program, the evaluation unit can be adapted to the demands to be met when using the stereo camera system. It is particularly advantageous when elements of an infrared illumination device are arranged on the board. In particular, infrared light-emitting diodes are arranged on the board and joined thereto by soldered joints. As a result thereof, an illumination of the detection range of the stereo camera system with the aid of these infrared light-emitting diodes is possible so that even in darkness usable images can be taken with the aid of the stereo camera system.

The stereo camera system can generate and/or process color images and/or black-and-white images.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying photographs, the latter being briefly described hereinafter.

### BRIEF SUMMARY OF THE DRAWINGS

FIG. 1 is a top view of a schematically illustrated board with two image detection sensors connected to the board and further elements connected to the board;

FIG. 2 is a side view of the schematically illustrated board according to FIG. 1.

FIG. 3 is a perspective top view of the board according to FIGS. 1 and 2 and two optical systems that can be coupled to the board; and

FIG. 4 shows a schematic structure of a stereo camera system with the board according to FIGS. 1 to 3.

### DETAILED DESCRIPTION OF THE ILLUSTRATIVE EMBODIMENT

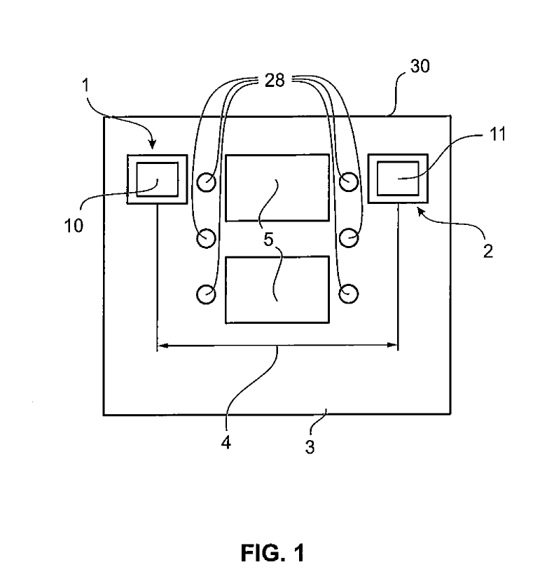

In FIG. 1, a top view of a schematically illustrated board 3 with two optical image detection sensors 1, 2 connected to the board 3 and further components 5, 28 connected to the board is shown. The board 3 comprises a substrate of insulating material having electrically conductive connections that electrically connect the electrical terminals of the components 1, 2, 5, 28 connected to the board 3 with one another. The electrically conductive connections are preferably designed as conducting tracks in the form of a printed circuit. The board 3 is, for example, made of phenol resin and paper, epoxy resin and paper or epoxy resin and glass-fiber fabric, and of conducting tracks or traces made of copper. Such a board 3 is also referred to as circuit board. Both the signal terminals and the terminals for power supply of the components 1, 2, 5, 28 are connected to electrical connections of the board 3. In addition to the electrical connections provided by the board 3, electrical connections can be provided via connecting lines for electrically connecting components 1, 2, 5, 28 on the board 3 and/or for connecting the board 3 to further units.

On the board 3, two image detection sensors 1, 2, preferably two identical optical semiconductor sensors 1, 2, are provided which are arranged at a distance 4 to each other that is predetermined by the printed circuit and which are electrically connected via a suitable connection to the conducting tracks of the board 3. The distance 4 between the center points of the image sensing areas 10, 11 of the image detection sensors 1, 2 preferably has a value in the range from 80 mm to 300 mm. The image detection sensors 1, 2 are joined to the board 3 by at least one soldered joint. Alternatively, the image detection sensors 1, 2 can be plugged into a respective socket joined to the board 3 by at least one soldered joint each. The image detection sensors 1, 2 are arranged on and connected to the board 3 such that, apart from small manufacturing tolerances, the image sensing areas 10, 11 of the image detection sensors 1, 2 are arranged in one plane. The marginal lines of the image sensing areas 10, 11 laterally formed in the illustration according to FIG. 1 by the pixel sensing elements (arranged in matrix form) are arranged in parallel to one another. The upper marginal lines of the image sensing areas 10, 11 formed by the pixel sensing elements in the illustration according to FIG. 1 lie on a first straight line. Likewise, the lower marginal lines of the image sensing areas 10, 11 formed by the pixel sensing elements lie on a second straight line. In the present embodiment, the upper marginal lines are further parallel to the upper edge 30 of the board 3 and have the same distance to the upper edge 30 of the board 3. In other embodiments, in particular in the case of other board shapes, the marginal lines of the image sensing areas 10, 11 do not have to be aligned in parallel to an edge of the board 3. The image sensing areas 10, 11 of the image detection sensors 1, 2 are located on the side of the respective image detection sensor 1, 2 facing away from the board 3.

The further components arranged on the board 3 comprise elements 5 of an evaluation unit to which the image data generated by the image detection sensors 1, 2 are transferred via the electrical connections provided by the board 3. The evaluation unit processes the image data with the aid of image processing algorithms provided by an image processing program. For this purpose, at least one image processing program is stored in the evaluation unit. For image processing, for example, digital signal processors (DSP), ASICs, FPAGs and/or vector processors can be used. Additionally or alternatively, also so-called logic arrays, such as PLDs, can be used for image processing.

Together with a non-illustrated camera optical system and the evaluation unit, the image detection sensors 1, 2 form a stereo camera system. Depending on the used image detection sensors 1, 2 and the image processing algorithms used by the evaluation unit, the stereo camera system can process and/or provide color images and/or black-and-white images.

By the stationary placement of the image detection sensors 1, 2 on the board 3 at a distance predetermined by the printed circuit of the board 3, the calibration expense is significantly reduced compared to other stereo camera systems of the prior art. The stereo camera systems of the prior art have two separate single cameras which are connected to an evaluation unit via one respective signal line each. The two single cameras of the stereo camera system or, respectively, their image detection sensors 1, 2 have to be calibrated exactly relative to each other to obtain correct results in the evaluation of the images taken by the stereo camera. The position of the single cameras of known stereo camera systems may change due to a large number of influences during operation, such as vibrations and temperature fluctuations. For this reason, the position of the single cameras of such known stereo camera systems has to be checked on a regular basis and, in the case of displacements, it has to be re-calibrated.

In the inventive stereo camera system, on the other hand, only a one-time calibration during assembly is required. A re-calibration of the stereo camera system is not required throughout the entire life as by fixing the image detection sensors 1, 2 on the board 3 the relative position of the image detection sensors 1, 2 to each other is invariable throughout the entire life. Further, by placing the two image detection sensors 1, 2 on only one board 3 a compact structure is achieved, as a result whereof the assembly work and the costs that will be incurred can be reduced.

In addition, components 28 of an infrared illumination device can be arranged on the board 3. In particular, at least one component 28 of the infrared illumination device is an infrared light-emitting diode. By using infrared light, the stereo camera system can also be used for image detection in the darkness as the detection range of the stereo camera system can be illuminated at least in part with the aid of the infrared illumination device.

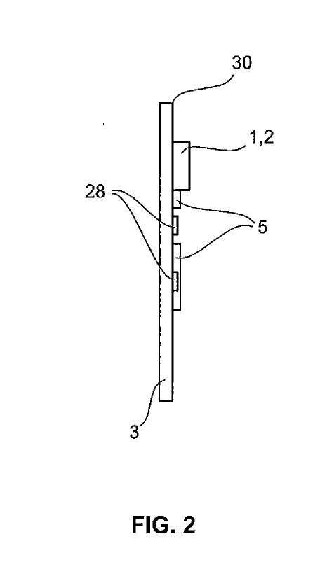

In FIG. 2, a side view of the schematically illustrated board 3 according to FIG. 1 is shown. Elements having the same structure or the same function are identified with the same reference signs.

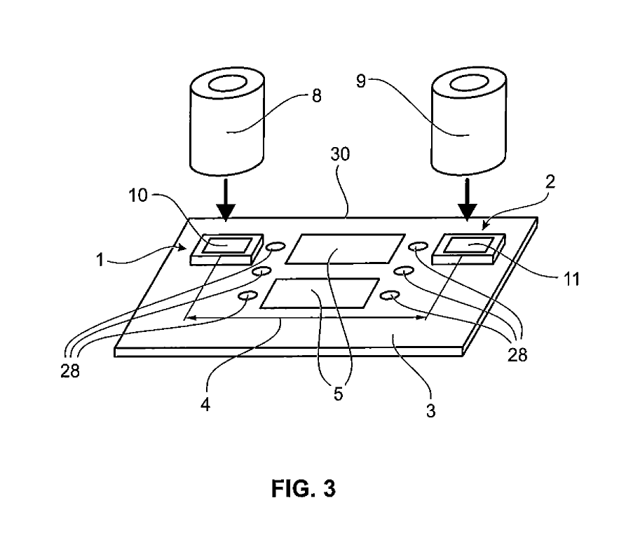

In FIG. 3, a perspective top view of the board 3 according to FIGS. 1 and 2 with two optical systems 8, 9 that can be coupled and uncoupled to and from the board 3 is illustrated. The two optical systems 8, 9 can be coupled to the board 3 such that the respective optical axis of an optical system 8, 9 runs through the center point of the image sensing area 10, 11 of an image detection sensor 1, 2. The optical systems 8, 9 are, for example, glued onto the board 3, screwed to the board 3, connected to the board 3 via suitable snap-in elements or connected to the board 3 via suitable clamping connections. Alternatively, the optical systems 8, 9 can also be integrated in a non-illustrated housing. The position of the optical systems 8, 9 relative to the image sensing areas 10, 11 is then fixed by the position of the housing relative to the board 3. The housing may serve to permanently protect the stereo camera system, for example, against splash water, coldness, rain and/or vandalism.

The optical systems 8, 9 each have one or more lenses and/or further optical elements and in particular serve to focus visual representations onto the image detection sensors 1, 2. By the selection of the optical systems 8, 9, the stereo camera system can be adapted to the desired focal length, light intensity and/or optical aperture.

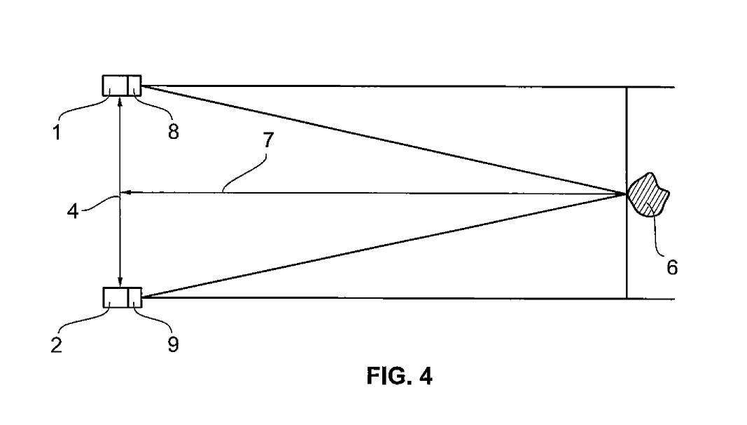

FIG. 4 shows the schematic structure of a stereo camera system according to FIGS. 1 to 3. The stereo camera system comprises the two image detection sensors 1, 2 arranged at the defined distance 4 to each other as well as the optical systems 8, 9. At a distance 7 in front of the stereo camera system, there is an object 6 to be detected. With the aid of the image detection sensors 1, 2 images with visual representations of the object 6 to be detected are taken. The image data generated by the image detection sensors 1, 2 and corresponding to the images taken are subsequently processed with the aid of the image processing algorithms provided by the evaluation unit with the aid of the executed image processing programs. For example, with the aid of the image processing algorithms provided by the evaluation unit with the aid of the image processing program objects 6 can be detected, tracked and/or measured. It is likewise possible to determine the distance of the object 6 to the stereo camera system.

CCD image detection sensors or CMOS image detection sensors are, for example, suitable as image detection sensors.

1. A stereo camera system with comprising:
a board; and
at least two coplanar image detection sensors connected to the board a predetermined fixed distance apart.

2. (canceled)

3. The stereo camera system according to claim 1 wherein the image detection sensors are optical semiconductor sensors, CCD image detection sensors and/or CMOS image detection sensors.

4. The stereo camera system according to claim 1 wherein the board is a circuit board.

5. The stereo camera system according to claim 1 wherein each of the image detection sensors has an image sensing area and the distance between the center points of the image sensing areas of the image detection sensors has a value in the range between 80 mm and 30 mm.

6. The stereo camera system according to claim 4 further comprising at least one evaluation unit connected to the board.

7. The stereo camera system according to claim 5 wherein at least one of the image detection sensors and the evaluation unit is connected to the board by a soldered joint, a plug connection and/or a press connection.

8. (canceled)

9. The stereo camera system according to claim 4 wherein a first marginal line of an image sensing area of a first image detection sensor and a first marginal line of an image sensing area of a second image detection sensor lie on a first straight line and/or a second marginal line of the image sensing area of the first image detection sensor and a second marginal line of the image sensing area of the second image detection sensor lie on a second straight line.

10. The stereo camera system according to claim 7,
characterized in that the marginal lines are each formed by pixel sensing elements of the image sensing areas.

11. The stereo camera system according to claim 5 wherein the evaluation unit executes at least one image processing program for processing the image data generated by the image detection sensors.

12. The stereo camera system according to claim 1 wherein at least one infrared illumination device is connected to the board.

13. The stereo camera system according to claim 1 wherein the stereo camera system generates and/or processes color images and/or black-and-white images.

14. The stereo camera system according to claim 1 wherein at least two optical systems are connected to the board and/or are arranged relative to the board such that one visual representation each of a detection range of the stereo camera system is imaged and/or focused onto one image sensing area each of the image detection sensors.

15. The stereo camera system according to claim 12, characterized in that the respective optical axis of an optical system runs through the center point of the image sensing area of an image detection sensor.

16. The stereo camera system according to claim 13 wherein the image detection sensors are identical and/or in that the optical systems are identical.

17. The stereo camera system according to claim 1 wherein the stereo camera system includes a housing that surrounds the board and the components connected to the board.
